(19) United States
(12) Patent Application Publication
(10) Pub. No.: US 2017/0343934 A1
(43) Pub. Date: Nov. 30, 2017

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Atsushi Yamazoe, Fuji Shizuoka (JP)

(21) Appl. No.: 15/438,984

(22) Filed: Feb. 22, 2017

(30) Foreign Application Priority Data
May 31, 2016 (JP) 2016-108326

(51) Int. Cl. G03G 15/20

(52) U.S. Cl. CPC G03G 15/2053

(57) ABSTRACT

An image forming apparatus, comprising a conveyance path configured to convey an image receiving medium; a fixing device configured to fix an image formed on the image receiving medium; a first roller arranged at the downstream side of a conveyance direction of the image receiving medium with respect to the fixing device, the first roller comprising an axis; a second roller configured to face the first roller and an end thereof of which protrudes towards a central part of the conveyance path with respect to an end of the first roller at the central part of the conveyance path in a first direction substantially parallel to the axis; and a protrusion arranged at the second roller side to protrude towards the first roller side from the second roller side and a protruding amount of which is greater than that of the second roller.

### CROSS-REFERENCE TO RELATED APPLICATIONS

This application is based upon and claims the benefit of priority from Japanese Patent Application No. 2016-108326, filed May 31, 2016, the entire contents of which are incorporated herein by reference.

### FIELD

Embodiments described herein relate generally to reducing damage to an image receiving medium at the time of discharging a sheet.

### BACKGROUND

An image forming apparatus discharges an image receiving medium passing through a fixing device to a discharge tray via a sheet discharge roller (for example, Japanese Unexamined Patent Application Publication No. 2007-217187). The image receiving medium is easily curved in a rotation direction of the fixing device through being pressurized and heated by the fixing device. If the image receiving medium in a curled state is discharged to the discharge tray, the image receiving medium curls and the loading property of the image receiving medium deteriorates. Thus, a correction member for correcting the curl of the image receiving medium is arranged at a mechanism part of the sheet discharge roller for discharging the image receiving medium to the discharge tray. However, in the process of correcting the curl of the image receiving medium with the function of the correction member, there are instances when the image receiving medium is damaged, for example, streaks are generated on the image receiving medium.

### DESCRIPTION OF THE DRAWINGS

FIG. 1 is a diagram illustrating an image forming apparatus;

FIG. 2 is a diagram illustrating the constitution of a sheet discharge roller;

FIG. 3 is an enlarged view of a first and the second roller pairs at the left side in FIG. 2.

FIG. 4 is an enlarged view of the first roller pair.

FIG. 5 is a diagram illustrating the constitution of the sheet discharge roller which may generate streaks on the image receiving medium;

FIG. 6 is an enlarged view illustrating the first roller pair which may generate streaks on the image receiving medium; and

FIG. 7 is an enlarged view illustrating the first and the second roller pairs which may generate streaks on the image receiving medium.

### DETAILED DESCRIPTION

Generally, in accordance with an embodiment, an image forming apparatus comprises a conveyance path, a fixing device, a first roller, an axis, a second roller and a protrusion. The conveyance path conveys an image receiving medium. The fixing device fixes an image formed on the image receiving medium. The first roller is arranged at the downstream side of a conveyance direction of the image receiving medium with respect to the fixing device. The axis is an axis of the first roller. The second roller faces the first roller and an end thereof protrudes towards a central part of the conveyance path with respect to an end of the first roller at the central part of the conveyance path in a first direction substantially parallel to the axis. The protrusion is arranged at the second roller side to protrude towards the first roller side from the second roller side and a protruding amount is greater than that of the second roller.

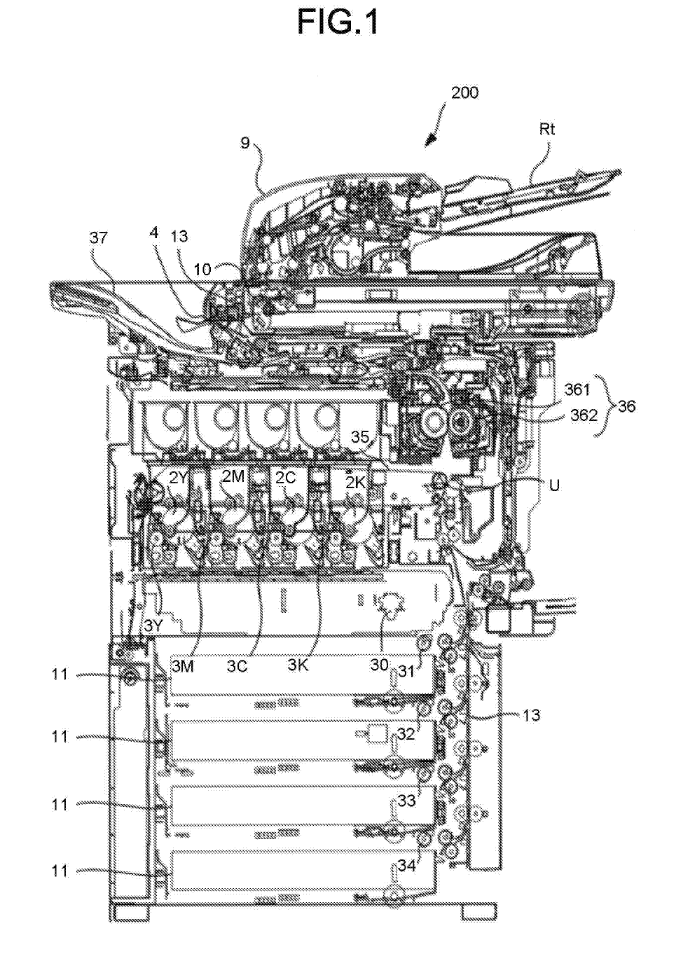

FIG. 1 is a diagram illustrating an image forming apparatus 200.

The image forming apparatus 200 reads a document on a document tray Rt by an automatic document feeder 9 with a scanning optical system 10. The image forming apparatus 200 has a cassette 11. The image receiving medium is placed in the cassette 11. The image forming medium is a sheet, an envelope, an OHP image recording medium and the like. The image forming apparatus 200 picks up the image receiving medium from the cassette 11 with pickup rollers 31˜34 to convey the image receiving medium to a conveyance path 13. The conveyance path 13 is a passage that extends from the cassette 11 side to a discharge tray 37 side to convey the image receiving medium.

Further, in the following description, since the image receiving medium is conveyed from the cassette 11 to the discharge tray 37, the cassette 11 side is set to an upstream side with respect to the conveyance direction of the image receiving medium, and the discharge tray 37 side is set to a downstream side with respect to the conveyance direction. The image forming apparatus 200 conveys the image receiving medium picked up from the cassette 11 by the pickup rollers to a secondary transfer position U by a conveyance roller and a resist roller.

The image forming apparatus 200 forms an electrostatic latent image on photoconductive drums 2Y˜2K (2Y, 2M, 2C and 2K, and other reference numerals are the same) by a laser optical system 30 based on image data of the document. The image forming apparatus 200 drives developing devices 3Y˜3K to develop the electrostatic latent images on the photoconductive drums 2Y˜2K with toner of Y˜K to form toner images of Y˜K on the photoconductive drums 2Y˜2K.

The image forming apparatus 200 transfers the toner images of Y˜K on the photoconductive drums 2Y˜2K onto a transfer belt 35 in the order of Y, M, C and K to form one color toner image on the transfer belt 35. The image forming apparatus 200 transfers the toner image on the transfer belt 35 onto the image receiving medium at the secondary transfer position U.

The image forming apparatus 200 heats the image receiving medium at a fixing device 36. The fixing device 36 fixes the toner image on the image receiving medium. The fixing device 36 has a heat source. The fixing device 36 has a heat roller 361 which is heated by the heat source and a pressure roller 362 which pressurizes the heat roller 361. The heat roller 361 is arranged at the transfer belt 35 side between two sides of the conveyance path 13 which face each other across the image receiving medium. The heat roller 361 heats a surface side of the image receiving medium where the toner image is formed at the time of a simplex printing. The type of the heat source is not limited. The heat source may be constituted by a lamp heater such as a halogen lamp or a resistance heating body such as a thermal head. The heat source may also be an IH (induction heating) type heater. The image discharge apparatus 200 discharges the image receiving medium after a fixing processing by the sheet discharge roller 4 to the discharge tray 37.

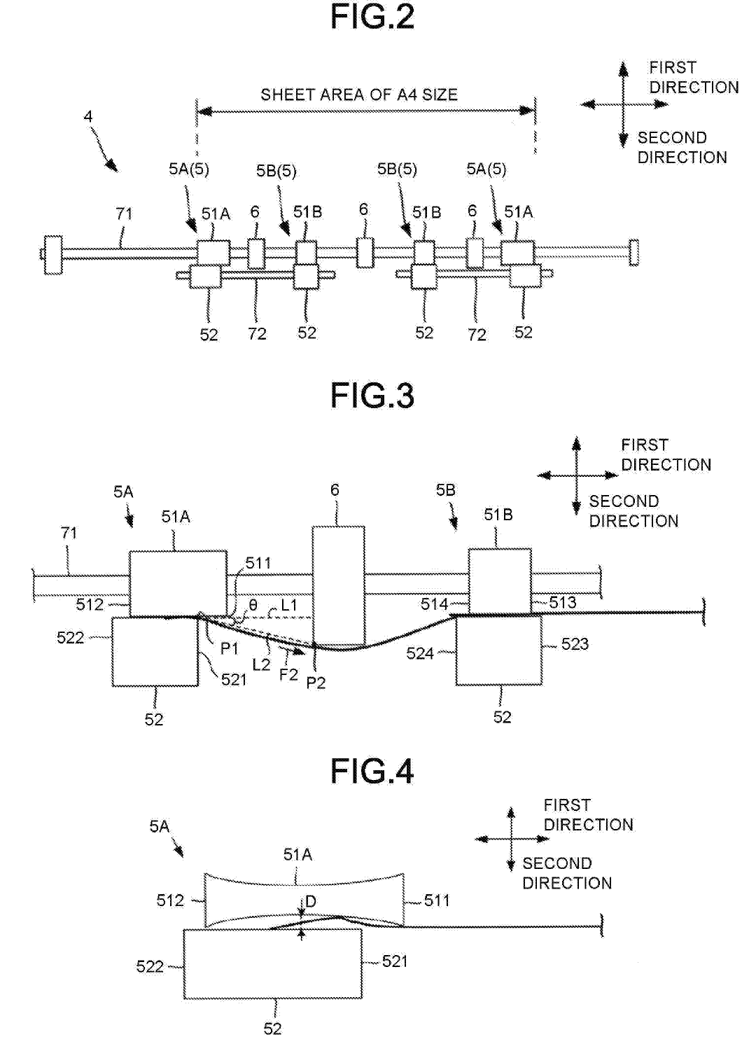

FIG. 2 is a diagram illustrating the constitution of the sheet discharge roller 4.

The sheet discharge roller 4 is a roller for conveying the image receiving medium to the discharge tray 37. The sheet discharge roller 4 is provided at the conveyance direction downstream side of the fixing device 36 and at the conveyance direction upstream side of the discharge tray 37.

The sheet discharge roller 4 is provided in the vicinity of the discharge tray 37. The image receiving medium is discharged to the discharge tray 37 by the sheet discharge roller 4. The sheet discharge roller 4 has a plurality of roller pairs 5. The sheet discharge roller 4 has a plurality of rollers for correction 6 (protrusion). The sheet discharge roller 4 also has a drive axis 71 and an axis 72 as the axes of the roller pair 5. Herein, an axial direction of the sheet discharge roller 4 (direction substantially parallel to the drive axis 71) is set to a first direction and a direction orthogonal to the first direction is set to a second direction.

The sheet discharge roller 4 has the function of correcting the curl of the image receiving medium. If the image receiving medium passes through the fixing device 36, since the image receiving medium receives heat and pressure from the fixing device 36, the image receiving medium sometimes curls. If the image receiving medium is discharged to the discharge tray 37 in a curled state, the loading property of the image receiving medium is impaired. Therefore, the sheet discharge roller 4 corrects the curl of the image receiving medium by bending the image receiving medium towards the second direction orthogonal to the axial direction of the sheet discharge roller 4.

The plurality of roller pairs 5 is positioned at intervals in the first direction orthogonal to the conveyance direction of the image receiving medium.

A first roller pair 5A includes a driving roller 51A (second roller) and a driven roller 52 (first roller). A second roller pair 5B includes a driving roller 51B (fourth roller) and a driven roller 52 (third roller). The driving rollers 51A and 51B are located at the transfer belt 35 and the heat roller 361 side between two sides of the conveyance path 13 which face each other across the image receiving medium. The driving rollers 51A and 51B contact the surface side of the image receiving medium on which the toner image is formed at the time of the simplex printing. The driving rollers 51A and 51B may be arranged at a side where there is no transfer belt 35 or the heat roller 361 between the two sides of the conveyance path 13 which face each other across the image receiving medium.

The driving rollers 51A and 51B are on the drive axis 71 rotated by a drive source (not shown). The driving rollers 51A and 51B have the same diameter. Both the driving rollers 51A and 51B face the driven rollers 52 and contact the driven rollers 52 in the absence of the image receiving medium. The driving roller 51A is longer than the driving roller 51B in the first direction.

The first roller pairs 5A are provided at positions corresponding to both ends of the image receiving medium with a predetermined size (for example, A4 size sheet). The second roller pairs 5B are sandwiched between the first roller pairs 5A. Hereinafter, the first roller pair 5A is described by taking a width of the A4 size as an example.

The driven rollers 52 of the first and the second roller pairs 5A and 5B have the same constitution. The driven rollers 52 are provided on the axis 72. The driven rollers 52 are rotatable and rotate along with the image receiving medium and the driving rollers 51A and 51B.

The rollers for correction 6 are arranged between the driving rollers 51A and 51B on the drive axis 71.

FIG. 3 is an enlarged view of a first and the second roller pairs 5A and 5B at the left side in FIG. 2. Hereinafter, in the first direction, a center side of the conveyance path 13 is described as a conveyance path center side (right side in FIG. 3), and an end side of the conveyance path 13 is described as a conveyance path end side (left side in FIG. 3).

In the first roller pair 5A, the driving roller 51A is longer than the driven roller 52 in the first direction. In the first direction, an end 511 of the driving roller 51A at the conveyance path center side protrudes towards the conveyance path direction center side with respect to an end 521 of the driven roller 52 at the conveyance path center side. In the first direction, an end 512 of the driving roller 51A at the conveyance path end side protrudes to the conveyance path center side with respect to an end 522 of the driven roller 52 at the conveyance path end side.

In the second roller pair 5B, the driving roller 51B is shorter than the driven roller 52 in the first direction. In the first direction, both ends 513 and 514 of the driving roller 51B are located between both ends 523 and 524 of the driven roller 52.

The roller for correction 6 has a larger diameter than the driving rollers 51A and 51B. In other words, the roller for correction 6 protrudes from the driving rollers 51A and 51B side to the driven roller 52 side, and a protrusion amount thereof is greater than that of the driving rollers 51A and 51B.

At the end 521 of the driven roller 52, a point at the end at the driving roller 51A side in the second direction is set to P1, and a line drawn from P1 to the first direction is set to L1. In the roller for correction 6, a point located at the driven roller 52 side in the second direction and also located at the end of the conveyance path end side is set to P2. A line for connecting the point P1 with P2 is set to L2. An angle θ formed by L1 and L2 is 4.6° or more.

FIG. 4 is an enlarged view of the first roller pair 5A.

An outer peripheral surface of the driving roller 51A is a concave curved surface of which the central part is recessed in the first direction.

An outer peripheral surface of the driven roller 52 is flat in the first direction.

A distance D in the second direction between the central part of the outer peripheral surface of the driving roller 51A in the first direction and the outer peripheral surface of the driven roller 52 is set to, for example, 20˜30 microns.

Hereinafter, first, the constitution of a sheet discharge roller 400 which may generate streaks on the image receiving medium and a function of the sheet discharge roller 400 on the image receiving medium are described. Next, the function of the sheet discharge roller 4 of the present embodiment on the image receiving medium is described. In the following description, each element of the sheet discharge roller 400 is donated with the same reference numeral as each element of the present embodiment.

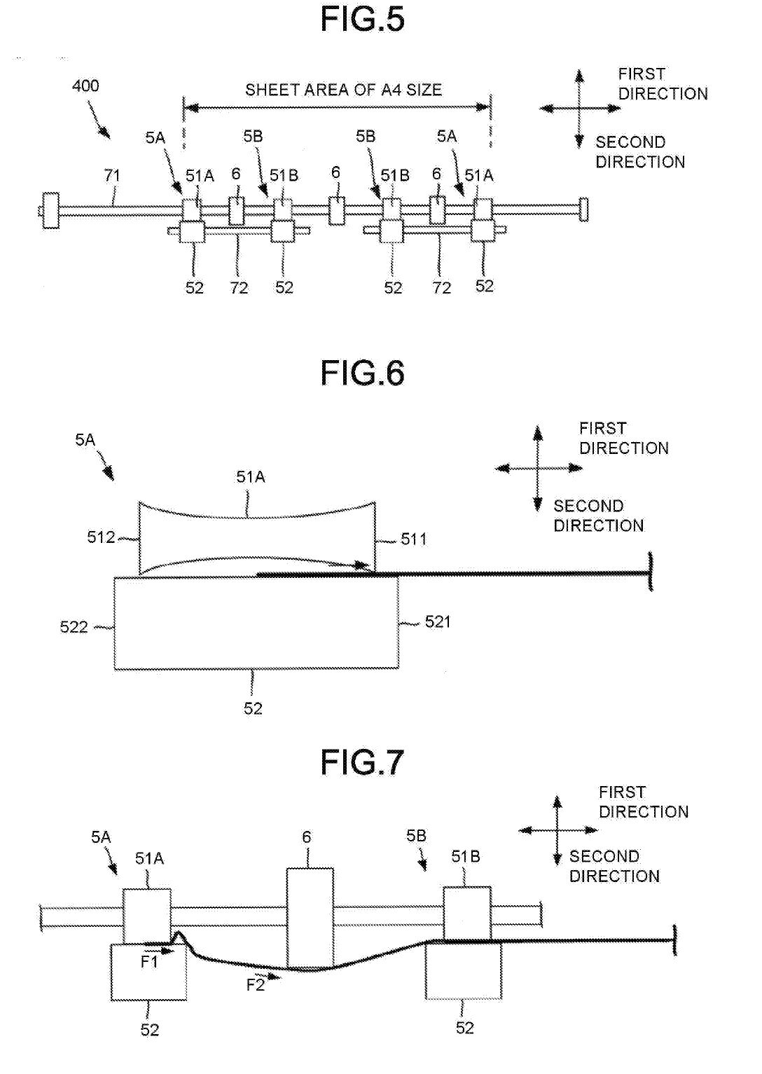

FIG. 5 is a diagram illustrating the constitution of the sheet discharge roller 400 which may generate streaks on the image receiving medium.

The constitution of the first roller pair 5A in the sheet discharge roller 400 is similar to that of the second roller pair 5B.

FIG. 6 is an enlarged view illustrating the first roller pair 5A which may generate streaks on the image receiving medium.

In the first roller pair 5A, the outer peripheral surface of the driving roller 51A is a concave curved surface of which the central part is recessed. In the first direction, both ends 511 and 512 of the driving roller 51A are located between both ends 521 and 522 of the driven roller 52.

In the sheet discharge roller 400, in a case in which an edge of the image receiving medium is located at the center of the first roller pair 5A, the center part of the driving roller 51A contacts with the edge of the image receiving medium, and the end 511 of the driving roller 51A in the conveyance path center side contacts with the edge of the image receiving medium at the conveyance path center side. As the outer peripheral surface of the driving roller 51A is a concave curved surface, a contact pressure at the end 511 of the driving roller 51A is larger than that at the center part. Thus, a force F1 is generated at the edge of the image receiving medium to pull the image receiving medium to the conveyance path center side.

FIG. 7 is an enlarged view illustrating the first and the second roller pairs 5A and 5B of the sheet discharge roller 400 which may generate streaks on the image receiving medium.

The image receiving medium is bent by the roller for correction 6 towards the driven roller 52 side in the second direction, and in this way, a force F2 is generated at the edge of the image receiving medium to pull the image receiving medium towards the conveyance path center side. In the constitution of the sheet discharge roller 400, by these forces F1 and F2, the edge of the image receiving medium is pulled towards the conveyance path center side from the first roller pair 5A, and there is a case in which streaks (creases) are generated on the image receiving medium.

Return to FIG. 4, in the present embodiment, the end 511 of the driving roller 51A at the conveyance path center side protrudes towards the conveyance path center side with respect to the end 521 of the driven roller 52 at the conveyance path center side. Thus, in the present embodiment, in a case in which the edge of the image receiving medium is positioned at the center of the first roller pair 5A, the end 511 of the driving roller 51A at the conveyance path center side does not sandwich the edge of the image receiving medium with the driven roller 52.

In this way, in the present embodiment, it is possible to suppress the generation of the force F1 for pulling the image receiving medium towards the conveyance path center side by the first roller pair 5A at the edge of the image receiving medium. Thus, in the present embodiment, as shown in FIG. 3, only the force F2 by the roller for correction 6 is applied to the edge of the image receiving medium. As the crease of the image receiving medium is not generated only with the force F2, in the present embodiment, it is possible to suppress the generation of streaks on the image receiving medium due to the first roller pair 5A. Thus, in the present embodiment, the damage to the image receiving medium at the time of discharging the sheet can be reduced.

In the present embodiment, as the roller for correction 6 rotates by receiving a drive force of a drive source in the same axis as the driving roller 51A, compared with a case of being located in the axis 72 of the driven roller 52, it is possible to act more strongly on the sheet and suppress the curl effectively.

In the present embodiment, it is possible to suppress the curl in which the image receiving medium warps back in the conveying direction. For example, in a case in which the image receiving medium is a sheet, at the time of fixing, in the image receiving medium, moisture moves at a surface side contacting with the pressure roller 362 at low temperature. Thus, the evaporation amount of moisture at the surface side contacting with the pressure roller 362 of the image receiving medium is larger than that of moisture at the surface side contacting with the heat roller 361. Thus, in the image receiving medium, the surface side contacting with the pressure roller 362 contracts and the conveyance path end side is easily curled toward the surface side contacting with the pressure roller 362. In the present embodiment, the roller for correction 6 presses the inner side (conveyance path center side) of the image receiving medium at the conveyance path end side toward the surface side contacting with the pressure roller 362, and thus, the curl can be suppressed effectively as compared with a case in which the inner side of the image receiving medium at the conveyance path end side is pressed towards the surface side contacting with the heat roller 361.

In the present embodiment, in the first roller pairs 5A corresponding to both ends of the image receiving medium with the predetermined size (for example, A4 size sheet), the end 511 protrudes towards the conveyance path center side with respect to the end 521 of the driven roller 52. Thus, the occurrence of the streak can be suppressed at both edges of the image receiving medium with the predetermined size.

In the first roller pair 5A for conveying the conveyance path end side of the image receiving medium with the predetermined size, the driving roller 51A is arranged to press the driven roller 52 to contact therewith, and the outer peripheral surface thereof becomes the concave curved surface. Thus, the end 512 as well as the center part of the driving roller 51A is also pressed to the driven roller 52 to contact therewith. Therefore, a sheet conveyance force of the first roller pair 5A in the present embodiment can be improved.

In the second roller pair 5B for conveying the conveyance path center side of the image receiving medium with the predetermined size, both ends 513 and 514 of the driving roller 51B are positioned at the inner side of both ends 523 and 524 of the driven roller 52. As the outer peripheral surface of the driving roller 51B becomes the concave curved surface, both ends 523 and 524 as well as the center part are sufficiently pressed towards the driven roller 52 to contact therewith. In this way, in the second roller pair 5B for conveying the conveyance path center side of the image receiving medium with the predetermined size, as a part where streaks are unlikely to occur is conveyed unlike the first roller pair 5A which conveys the conveyance path end side of the image receiving medium, the second roller pair 5B is constituted with emphasis on the conveyance force. Thus, the conveying roller 4 in the present embodiment can efficiently realize the conveyance force and the suppression of damage to the image receiving medium at the time of discharging the sheet.

(Modification)

The first roller pair 5A may be located at positions corresponding to both ends of the image receiving medium with other sizes than A4 size in the first direction.

Even in the second roller pair 5B, the end 513 of the driving roller 51B at the conveyance path center side may protrude towards the conveyance path center side with respect to the end 523 of the driven roller 52 at the conveyance path center side.

The roller for correction 6 may not be coaxial with the driving rollers 51A and 51B. The roller for correction 6 may be optional as long as it is located at the driven roller 52 side protruding towards the conveyance path center side or the driving rollers 51A and 51B side.

The protrusion may not be a roller as in the present embodiment. The protrusion may be located at a position shifted from the driving rollers 51 A and 51B and the driven rollers 52 in the first direction. The protrusion is optional as long as it bends the sheet in an out-of-surface direction in order to suppress the curl due to heat of the sheet after the fixing processing. The protrusion may be coaxial with the driven roller 52 or may be on an axis on which there are no driving rollers 51A and 51B or the driven rollers 52. The protrusion may not be in the same position as the driving rollers 51A and 51B or the driven roller 52 in the sheet conveyance direction.

What is claimed is:

1. An image forming apparatus, comprising:
a conveyance path configured to convey an image receiving medium;
a fixing device configured to fix an image formed on the image receiving medium;
a first roller arranged at the downstream side of a conveyance direction of the image receiving medium with respect to the fixing device, the first roller comprising an axis;
a second roller configured to face the first roller and an end thereof of which protrudes towards a central part of the conveyance path with respect to an end of the first roller at the central part of the conveyance path in a first direction substantially parallel to the axis; and
a protrusion arranged at the second roller side to protrude towards the first roller side from the second roller side and a protruding amount of which is greater than that of the second roller.

2. The image forming apparatus according to claim 1, further comprising:
a drive source; wherein
one of the first roller and the second roller comprises a driving roller driven by a drive force of the drive source, and
an outer peripheral surface of the driving roller is a concave curved surface of which a center part is recessed in the first direction.

3. The image forming apparatus according to claim 2, wherein
an outer peripheral surface of the driven roller is a flat surface in the first direction.

4. The image forming apparatus according to claim 1, further comprising:
a drive source; wherein
the second roller is a driving roller driven by a drive force of the drive source, and
the protrusion comprises a roller located on the same axis as the driving roller.

5. The image forming apparatus according to claim 2, wherein
the other of the first roller and the second roller is a driven roller for rotating along with the sheet, and
the driving roller is longer than the driven roller in the first direction.

6. The image forming apparatus according to claim 5, wherein
an outer peripheral surface of the driven roller is a flat surface in the first direction.

7. The image forming apparatus according to claim 1, further comprising:
a plurality of roller pairs arranged at intervals in the first direction, wherein
the roller pairs comprise two first roller pairs corresponding to both ends of the image receiving medium with a predetermined size in the first direction and two second roller pairs between the two first roller pairs in the first direction,
the first roller pair comprises the first roller and the second roller,
the second roller pair comprises a third roller and a fourth roller facing the third roller and on the same axis as the second roller, and
in the second roller pair, the fourth roller is shorter than the third roller in the first direction and both ends of the fourth roller in the first direction are located between both ends of the third roller.

8. The image forming apparatus according to claim 1, further comprising:
at least two roller pairs arranged at intervals in the first direction.

9. The image forming apparatus according to claim 1, wherein
the protrusion comprises a roller.

10. The image forming apparatus according to claim 9, wherein
the protrusion is configured to bend the image receiving medium in an out-of-surface direction to suppress curling.

11. The image forming apparatus according to claim 2, wherein
the protrusion is positioned coaxial with the driven roller.

12. The image forming apparatus according to claim 2, wherein
the protrusion is positioned so not to be coaxial with the driven roller.

13. A method of reducing curl after forming an image on an image receiving medium, comprising:
forming the image on the image receiving medium using the image forming apparatus according to claim 1.

14. A method of reducing streaks after forming an image on an image receiving medium, comprising:
forming the image on the image receiving medium using the image forming apparatus according to claim 2.

15. The method of reducing streaks according to claim 14, wherein
a contact pressure at an end of the driving roller with the image receiving medium is larger than a contact pressure at a center part of the driving roller with the image receiving medium.
